(19) United States
(12) Patent Application Publication
(10) Pub. No.: US 2023/0186900 A1
(43) Pub. Date: Jun. 15, 2023

(54) METHOD AND SYSTEM FOR END-TO-END AUTOMATIC SPEECH RECOGNITION ON A DIGITAL PLATFORM

(71) Applicant: FLIPKART INTERNET PRIVATE LIMITED, Bengaluru (IN)

(72) Inventors: Raviraj Joshi, Pune (IN); Subodh Kumar, Bengaluru (IN); Anupam Singh, Bangalore (IN)

(73) Assignee: FLIPKART INTERNET PRIVATE LIMITED, Bengaluru (IN)

(21) Appl. No.: 18/077,617

(22) Filed: Dec. 8, 2022

(30) Foreign Application Priority Data
Dec. 11, 2021 (IN) 202141057646

(51) Int. Cl. G10L 15/06; G10L 15/26; G10L 25/30

(52) U.S. Cl. CPC G10L 15/063; G10L 15/26; G10L 25/30

(57) ABSTRACT

The present disclosure relates to a method and system for end-to-end automated speech recognition on a digital platform. Said method comprises: (1) receiving, via a recorder [102], a speech input in a target domain; (2) processing, by a first sub-system [104], the speech input based on a data output from a second sub-system [106] and a pre-trained third sub system [108], wherein the pre-training of the third sub-system [108] is based on a historical audio data in a source domain retrieved from a memory unit [110]; and (3) generating, by the first sub-system [104], a text output for the speech input based on the processing of the first sub-system [104]. The method obtains a low-cost system and method for end-to-end automatic speech recognition with high accuracy.

### RELATED APPLICATION

This application claims priority under 35 U.S.C. § 119 to Indian Patent Application No. 202141057646, filed on Dec. 11, 2021, the entire contents of which are incorporated herein by reference

### FIELD OF THE DISCLOSURE

The present disclosure relates generally to the field of speech recognition. More particularly, the disclosure relates to methods and systems for end-to-end automatic speech recognition.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Automatic speech recognition (ASR) is the most important component in building voice-based interfaces. It is a technology that allows people to use their voice to communicate with a computer interface for converting the data contained in their speech into text format. The feature of transcribing speech has been one of the important and widely deployed applications of the ASR systems. These voice-based interfaces also find applications in smart home appliances, voice queries on assistants, voice search in applications or web, voice dialing, simple data entry, etc. The system built for one domain for example voice search on fashion products may not work very well for other domains like voice search on medical products. Therefore, a custom solution is needed for each domain until truly generalizable solutions can be built.

Further, ecommerce platforms have changed the way the consumers shop. As a result of availability of more and more products on the ecommerce platforms, the transactions on these platforms and their usage has increased significantly. Thus, in the rising ecommerce trends, the usage of automatic speech recognition systems is also increasingly being adopted by the users.

Speech recognition systems require training using training data to learn various voices, dialects, tonal qualities of various people for an increased accuracy. Thus, the end-to-end speech recognition systems require a large amount of training data to achieve good performance. The training data consists of audio-text pairs transcribed manually using human annotators. Thus, it is expensive to create real audio-text pairs for training end-to-end automatic speech recognition (ASR) systems.

Time and again, various systems and methods have been coined to provide systems with higher accuracy or lower costs. However, the problem with the existing systems is that the highly accurate systems are very expensive and are thus not in reach of most of the people to for use. Further, the low cost end to end ASR systems do not provide accurate results, at least not generally in all domains.

Thus, in order to train ASR systems for low resource domains, model-specific approaches and data-specific approaches have been proposed in the art.

A small amount of real audio-text pairs in a desired field as well as having specific audio characteristics such as frequency, texture of sound, etc. can manually be created and used to train a system. However, this approach is susceptible to overfitting, that is, learning of noise, along with the desired training data, by the system, thus reducing the efficiency of the system, as the data in the desired field is very less. Alternatively, the data can be mixed with data from other fields and collectively used to train the network. In this case, the accuracy of the system for the desired field might still be poor.

Further, leveraging external language models trained on target text data is another technique used to improve ASR systems on the target domain. But since these additions do not affect the ASR model the scope of improvements is limited.

Also, a text-to-speech (TTS) system can be leveraged to generate synthetic audio-text pairs from the text-only data. This synthetic data can further be used to train the ASR model. But the problem with synthetic data is that the audio does not resemble real-world audio. This leads to poor performance of ASR system on the real-world data. A number of techniques have been proposed to effectively use the TTS data. This mostly filters down to having enough variability in the audio data by having multiple speakers and adding external noise to the audio samples. However, it is costly to build a multi-speaker TTS system and the external noise may not exactly resemble the real-world scenario.

Thus, there exists an imperative need in the art to provide a low-cost system and method for end to end automatic speech recognition with high accuracy. This will help saving the money and thus will allow widespread usage of the technology that will contribute to better customer experience.

### SUMMARY

This section is intended to introduce certain objects and aspects of the disclosed method and system in a simplified form and is not intended to identify the key advantages or features of the present disclosure.

One aspect of the present disclosure relates to a system for end-to-end automatic speech recognition, the system comprising a recorder [102] configured to receive a speech input in a target domain. Then, a first sub-system is provided that is configured to process the speech input based on a data output from a second sub-system and a pre-trained third sub system. The pre-training of the third sub-system is based on a historical audio data in a source domain retrieved from a memory unit. Finally, the first sub-system is configured to generate a text output for the speech input based on the processing of said first sub-system.

Another aspect of the present disclosure relates to a method for end-to-end automatic speech recognition, the method comprising: (1) receiving, via a recorder, a speech input in a target domain; (2) processing, by a first sub-system, the speech input based on a data output from a second sub-system and a pre-trained third sub system, wherein the pre-training of the third sub-system is based on a historical audio data in a source domain retrieved from a memory unit; and (3) generating, by the first sub-system, a text output for the speech input based on the processing of the first sub-system.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings.

Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an architecture of a system for end-to-end automatic speech recognition on a digital platform, in accordance with exemplary embodiments of the present disclosure.

FIG. 2 illustrates an exemplary method flow diagram depicting a method for end-to-end automatic speech recognition on a digital platform, in accordance with exemplary embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, “recorder” refers to an audio recording service that comprises atleast a microphone, a processor, and a memory unit. It allows one to record the data that is being fed to the microprocessor, for later use and further analysis of the data. That may allow one to analyse more effectively the users’ requirements, their behaviour, their dialects, their tonal quality, voice texture, etc. Further, an audio recorder is a digital device that captures audio data, saves it as a file in a file format such as mp3, aac, wav, aiff, flac, wma, etc. and then may transmits it to another device, such as a computer. This transmitting of audio data can be done in real time for further processing of data.

As used herein, a domain can be referred to in the context of audio and text. The audio domain corresponds to the recording device and external recording conditions for example recording may be done in a closed room using a mobile phone. The text domain corresponds to the linguistic domain of the spoken utterance, for example, the text can come from the e-commerce or medical domain.

In a known solution, an end-to-end automatic speech recognition (ASR) system is built which requires a large amount of training data to achieve good performance. The training data consists of audio-text pairs transcribed manually using human annotators.

However, a major drawback of this system is that it requires creating real audio-text pairs for training end-to-end ASR systems which is very expensive to create. Further, in order to train ASR systems for low resource domains, a small amount of real audio-text pairs (target domain) manually created can also be used to fine-tune the neural network model. Even in such a case, the approach is susceptible to overfitting as the target domain data is very less.

In another known solution, an end-to-end automatic speech recognition (ASR) system is built in which a text-to-speech (TTS) system is leveraged to generate synthetic audio-text pairs from the text-only data. This synthetic data can further be used to train the ASR model.

However, a major drawback of this approach is that the synthetic data audio does not resemble real-world audio. This leads to poor performance on text data. Further to overcome this, one can have enough variability in the audio data by having multiple speakers and adding external noise to the audio samples. However, again the major drawback with this approach is that it is costly to build a multi-speaker TTS system and the external noise may not exactly resemble the real-world scenario.

Thus, it is known in the existing art that a lot of training data is needed for the training of end-to-end automatic speech recognition (ASR) systems for achieving a good performance. The problem is that training data is not that easy to get for every domain, and the cost involved in training the systems using training data for a particular domain is very high. Further, the training data available for training the ASR systems faces the challenges due to difference in domain, that is, the training systems trained in one domain perform poorly for the applications in another domain. If one does not have a training data in a domain, it is difficult to train the ASR systems in that particular domain. Further, it is very difficult and costly to train a generic model common for all domains, that is why domain-specific models are usually trained. The present invention tries to address this issue by obtaining a system and a method in which the training data of any domain can be used to train the ASR system in a target domain.

The proposed solution provides a complete end-to-end process to train an ASR model for the required audio domain and text-domain where corresponding audio-text pairs are not available. Audio-text samples from one source text domain (for example, e-commerce voice search domain) and only text samples from the target-text domain (for example, address domain) are required. The audio domain of the target can be anything with the extreme case being synthetic audio samples. The final system is interested in the audio domain of the source data. This will allow one skilled in the art to train a final model with audio characteristics of the source data and the linguistic characteristics of the target data.

Thus, in the method of the present disclosure, an ASR system is trained on the source audio-text pair representing the acoustic conditions. This ASR system is tuned to the final audio domain but there is a mismatch in the text domain. Next, a single speaker text to speech (TTS) engine and text-only data is leveraged to generate audio-text pairs for the target domain. Finally, this single speaker TTS data can be used to adapt a neural network system to the new target domain without overfitting to the single speaker acoustic conditions. In order to surpass this overfitting, a fine-tuning approach is followed where it is proposed to fine-tune only the final dense layer of the neural network so that the acoustic part of the network is not affected by the single speaker data. The synthetic data can be replaced with any real acoustic data which does not represent target acoustic conditions but represents the target text.

Hereinafter, exemplary embodiments of the present disclosure will be described in detail with reference to the accompanying drawings so that those skilled in the art can easily carry out the solution provided by the present disclosure.

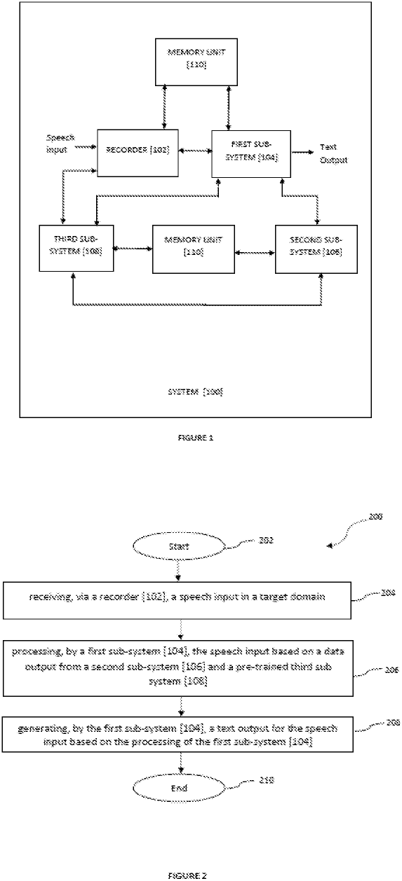

FIG. 1 illustrates an architecture of a system for end-to-end automatic speech recognition on a digital platform. As shown, the system [100] comprises a recorder [102], a first sub-system [104], a second sub-system [106], a third sub-system [108], and a memory unit [110].

The recorder [102] is configured to receive an audio data in a target domain. The data can be anything spoken by a user, or any other source. In an implementation, the recorder [102] can record the audio data in the target domain and save it for further training of the system [100], and also can transmit the received audio data in real time for using in further processing of speech recognition. For example, the target domain on a digital platform can be an “address domain” which refers to the domain of an address field where a user provides an address of a location as input to the digital platform. So, the user wants to use the automatic speech recognition system for entering his address in the address field on the digital platform, and the domain of the spoken text for entering this address is the “address domain”. Now, the ASR system is not trained for translating speech to text in address domain. Also, there is no data available in the address domain. In this example, the system uses a pre-trained sub-system (called as ‘third sub-system [108]’ for the purposes of the present disclosure) that has been trained on a data set of another domain, say, a search query domain. This will be referred to as the ‘source domain’ for the purposes of this example.

Thus, the third sub-system [108] is a pre-trained sub-system trained on the search query domain. In an implementation, the recorder [102] is operably coupled with the third sub-system [108] and is configured to send audio data to the third sub-system [108] for training purposes. Further, the audio data of the recorder [102] can be provided to the third sub-system [108] via a memory unit coupled with both the recorder [102] and the third sub-system [108]. In the above example, the audio data in a source domain recorded by the recorder [102] can be sent to third sub-system [108] via the memory unit [110].

The third sub-system [108] is configured to convert the audio to text data and generate audio-text pairs for the audio retrieved from the memory unit [110]. In an implementation, the third sub-system [108] is a learning device that is pre-leamed from a set of initial data provided to develop the third sub-system [108] to convert text in the source domain. Further in an implementation, the third sub-system [108] is a dynamically learning system that learns from the new data provided. Further, the audio-text pairs generated by the third sub-system [108] are in source domain and not in target domain. Also, in an implementation, the source acoustic conditions are preferably same as the target acoustic conditions. This, for example, can be obtained by implementing the third sub-system [108] and the first sub-system [104] on the same digital platform. Thus, a model from the third sub-system [108] is obtained and provided to the first sub-system [104].

Further, the text data obtained on the digital platform in the target domain is provided to the second sub-system [106]. In an implementation, the second sub-system [106] is a text to speech (TTS) engine. Thus, in the above example, if text data of the address domain is provided to the second sub-system [106], the audio-text pairs in the target domain can be obtained. In an implementation, the second sub-system [106] or the text to speech engine is a single-speaker text to speech engine. Thus, one obtains the audio-text pairs data for a single speaker.

As used herein, a single speaker data refers to the data obtained from a single person, i.e., speaker, spoken in single speaking style. Also, a multiple-speaker data refers to the data obtained from multiple speakers, that is, people with different tones, different frequency, different dialects. It is pertinent to note that the single speaker TTS engine data can be obtained at a very low cost, however, it is very inaccurate when implemented practically. Further, the multiple speaker TTS engine data is desirable as the output of the ASR system comprising a multiple speaker TTS engine is accurate. However, such a system is very costly to obtain.

Thus, in order to obtain highly accurate data at a low cost, that is, by using a single speaker TTS engine, the model obtained from the third sub-system [108] and the single speaker TTS engine data obtained from the second sub-system [106] is provided to the first sub-system [104]. The model obtained from the third sub-system [108] is trained on a source domain. And, the data obtained from the second sub-system [106] is a single speaker audio-text pair data. Thus, in an implementation, a neural network based model comprising multiple layers is implemented in the first sub-system [104]. The multiple layers of this first sub-system [104] comprise multiple initial layers and a final dense layer. In an implementation, the multiple initial layers of the first sub-system [104] are frozen, meaning thereby, these frozen layers are not modified or trained once implemented. Only the final dense layer, that is, the final layer of the first sub-system [104] is trained or fine-tuned using the model obtained from the third sub-system [108] and the data of the second sub-system [106]. This fine-tuning of only the final dense layer saves a lot of cost as it does not require training of the entire model. In an implementation, the first sub-system [104] is configured to chunk the audio into pieces of a predefined length or audio is provided to the first sub-system [104] in chunks of a predefined length. For example, the audio provided to the first sub-system [104] is chunked into pieces of 20 ms each. A person skilled in the art would appreciate that the predefined length of 20 ms is only exemplary and does not restrict the present disclosure in any possible manner.

In an implementation, the first sub-system [104] is a connectionist temporal classification (CTC)- based system with a plurality of initial long short term memory (LSTM) layers followed by a final dense layer. In another implementation, the first sub-system [104] is an encoder-decoder based system with a plurality of stacked long short term memory (LSTM) layers on the encoder side as well as decoder side. In the encoder-decoder based system, either only the final dense layer or even the entire decoder can be fine-tuned as a part of the final step. A person skilled in the art would appreciate that the long short term memory (LSTM) layers are only exemplary and other layers such as Transformer layers or any other type of suitable layers are encompassed by this disclosure. Accordingly, the LSTM layers do not limit or restrict the disclosure in any possible manner. Also, the final layer predicts the word from the speech input or the audio by analyzing the chunks of audio pieces of a predefined length provided to it as input. For example, an audio piece can be of length 20 ms. A person skilled in the art would appreciate that the predefined length of 20 ms is only exemplary and does not restrict the present disclosure in any possible manner.

Further, since the source acoustic condition and target acoustic condition is same, only this final layer in the first sub-system [104] is trained instead of training the whole model. Thus, the initial layers in the first sub-system [104] which process the audio data based on the pre-trained third sub-system [108], that is, processing of the acoustic conditions of the audio data, are not trained or altered.

In an implementation, the first sub-system [104] is a system for training a neural network for an end-to-end automatic speech recognition system. The system comprises a plurality of layers, configured to receive a speech input data. The second sub-system [106] is configured to obtain an audio-text pair data in a target domain from a text data in the target domain. This audio-text pair data in the target domain obtained from the second sub-system [106] is a single speaker audio-text pair data based on an input text in the target domain. Further, the third sub-system [108] is pre-trained using a set of audio data in a source domain. And, the first sub-system [104] is finally configured to fine-tune a final layer of the first sub-system [104] using the audio-text pair data obtained using the second sub-system [106] and the pre-trained third sub-system [108]. Further, the speech input is chunked into a plurality of pieces of a predefined length.

Referring to FIG. 2, an exemplary method flow diagram depicting a method for end-to-end automatic speech recognition on a digital platform. The method starts at step 202 and goes to step 204. At step 204, the recorder [102] receives an audio data in a target domain. The data can be anything spoken by a user, a user equipment/device, or any other source, for example, a user wants the system to generate text in “address domain”, and therefore, the data received from the user is an address domain data. In an implementation, the recorder [102] can record the audio data in the target domain and save it for further training of the system [100], and also can transmit the received audio data in real time for further process of speech recognition. Following the above example, the target domain on a digital platform is an “address domain”. So, the user wants to use the automatic speech recognition (ASR) system for entering his address in the address field on a digital platform. Now, the ASR system is not trained for translating speech to text in address domain. Also, there is no audio data available in the address domain. In this example, the method uses a pre-trained sub-system (called as ‘third sub-system [108]’ for the purposes of the present disclosure) that has been trained on a data set of another domain, say, a search query domain. This will be referred to as the ‘source domain’ for the purposes of this example. A person skilled in the art would appreciate that the address domain and search query domain are only exemplary and do not restrict the present disclosure in any possible manner. Other domains of data source and target text domains can also be implemented and are under purview of the present disclosure.

At step 206, the first sub-system [104] processes the speech input based on a data output from the second sub-system [106] and the pre-trained third sub system [108]. The third sub-system [108] is a pre-trained sub-system trained on the search query domain. In an implementation, the recorder [102] is operably coupled with the third sub-system [108] and is configured to send audio data to the third sub-system [108] for training purposes. Further, the audio data of the recorder [102] can be provided to the third sub-system [108] via a memory unit [110] coupled with both the recorder [102] and the third sub-system [108]. In the above example, the audio data in a source domain recorded by the recorder [102] can be sent to third sub-system [108] via the memory unit [110].

Further, as a part of step 206, the third sub-system [108] converts the audio to text data and generate audio-text pairs for the audio retrieved from the memory unit [110]. In an implementation, the third sub-system [108] is a learning device that is pre-learned from a set of initial data provided to develop the third sub-system [108] to convert text in the source domain. Further in an implementation, the third sub-system [108] is a dynamically learning system that learns from the new data provided. Further, the audio-text pairs generated by the third sub-system [108] are in source domain and not in target domain. Also, in an implementation, the source acoustic conditions are preferably same as the target acoustic conditions. This, for example, can be obtained by implementing the third sub-system [108] and the first sub-system [104] on the same digital platform. Thus, a model from the third sub-system [108] is obtained and provided to the first sub-system [104].

Further, in the processing done in the same step 206, the text data obtained on the digital platform in the target domain is provided to the second sub-system [106]. In an implementation, the second sub-system [106] is a text to speech (TTS) engine. Thus, in the above example, if text data of the address domain is provided to the second sub-system [106], the audio-text pairs in the target domain are obtained. In an implementation, the second sub-system [106] or the text to speech engine is a single-speaker text to speech engine. Thus, one obtains the audio-text pairs data for a single speaker.

As used herein, a single speaker data refers to the data obtained from a single person, i.e., speaker, spoken in single speaking style. Also, a multiple-speaker data refers to the data obtained from multiple speakers, that is, people with different tones, different frequency, different dialects. It is pertinent to note that the single speaker TTS engine data can be obtained at a very low cost, however, it is very inaccurate when implemented practically. Further, the multiple speaker TTS engine data is desirable as the output of the ASR system comprising a multiple speaker TTS engine is accurate. However, such a system is very costly to obtain.

Thus, in order to obtain highly accurate data at a low cost, that is, by using a single speaker TTS engine, the model obtained from the third sub-system [108] and the single speaker TTS engine data obtained from the second sub-system [106] is provided to the first sub-system [104]. The model obtained from the third sub-system [108] is trained on a source domain. And, the data obtained from the second sub-system [106] is a single speaker audio-text pair data. Thus, in an implementation, a neural network based model comprising multiple layers is implemented in the first sub-system [104]. For understanding, let us call the multiple layers of this first sub-system [104] as initial layers and the final layer. In an implementation, the initial layers of the first sub-system [104] are frozen, meaning thereby, these frozen layers are not modified or trained once implemented. Only the final layer of the first sub-system [104] is trained or fine-tuned using the model obtained from the third sub-system [108] and the data of the second sub-system [106]. This fine-tuning of only the final layer saves a lot of cost as it does not require training of the entire model. The first sub-system [104] is configured to predict the word from audio. In an implementation, then first sib-system [104] is configured to chunk the audio into pieces of a predefined length or audio is provided to the first sub-system [104] in chunks of a predefined length. For example, the audio provided to the first sub-system [104] is chunked into pieces of 20 ms each. A person skilled in the art would appreciate that the predefined length of 20 ms is only exemplary and do not restrict the present disclosure in any possible manner.

Further, since the source acoustic condition and target acoustic condition is same, only this final layer in the first sub-system [104] is trained instead of training the whole model. Thus, the initial layers in the first sub-system [104] which process the audio data based on the pre-trained third sub-system [108], that is, processing of the acoustic conditions of the audio data, are not trained or altered. Based on this processing of the first sub-system [104], a text output for the speech input is generated by the first sub-system [104]. Thus, the process ends at step 210.

In an implementation, the first sub-system [104] is a neural network comprising plurality of layers. In this, the method of training the neural network comprises: receiving a speech input data by the first sub-system [104]. Further, an audio-text pair data in a target domain is obtained from a text data in the target domain using a second sub-system [106]. This audio-text pair data in the target domain obtained from the second sub-system [106] is a single speaker audio-text pair data based on an input text in the target domain. Further, the third sub-system [108] is pre-trained using a set of audio data in a source domain. Finally, the final layer of the first sub-system [104] is fine-tuned using the audio-text pair data obtained using the second sub-system [106] and the pre-trained third sub-system [108]. Also, the speech input is chunked into a plurality of pieces of a predefined length. For example, the predefined length can be 20 ms for each chunk of audio data. A person skilled in the art would appreciate that the predefined length of 20 ms is only exemplary and do not restrict the present disclosure in any possible manner.

Thus, by practicing and implementing the method and system as illustrated in the above discussion, a person skilled in the art would be able to obtain a low-cost system and method for end to end automatic speech recognition with high accuracy. A person skilled in the art would require audio-text samples from a source text domain, for example, an e-commerce voice search domain, and only text samples from a target-text domain, for example, address domain. Further, the audio domain of the target can be anything with the extreme case being synthetic audio samples. The sub-systems of the present disclosure use only the audio domain of the source data to train the system with audio characteristics of the source data and the linguistic characteristics of the target data. This is done by feeding the data obtained using a low-cost single speaker TTS engine as the second sub-system [106] and the model obtained from the third sub-system [108], to train the final layer of the first sub-system [104]. Now since there is no requirement of multiple speaker audio-text pair data, the highly accurate audio speech recognition system can be obtained at a low cost. This creates multiple avenues for application including smart home appliances, voice queries on assistants, voice search in applications or web, voice dialing, simple data entry, and other applications where at least the users were restricted to use the ASR systems due to high cost or low accuracy of the systems.

While considerable emphasis has been placed herein on the disclosed embodiments, it will be appreciated that many embodiments can be made and that many changes can be made to the embodiments without departing from the principles of the present disclosure. These and other changes in the embodiments of the present disclosure will be apparent to those skilled in the art, whereby it is to be understood that the foregoing descriptive matter to be implemented is illustrative and non-limiting.

We claim:

1. A method for end-to-end automated speech recognition, the method comprising:
- receiving, via a recorder [102], a speech input in a target domain;
- processing, by a first sub-system [104], the speech input based on a data output from a second sub-system [106] and a pre-trained third sub system [108], wherein the pre-training of the third sub-system [108] is based on a historical audio data in a source domain retrieved from a memory unit [110]; and
- generating, by the first sub-system [104], a text output for the speech input based on the processing of the first sub-system [104].

2. The method as claimed in claim 1, wherein the data output from the second sub-system [106] is a single speaker audio data based on an input text in the target domain.

3. The method as claimed in claim 1, wherein the speech input is chunked into a plurality of pieces of a predefined length.

4. The method as claimed in claim 1, wherein the first sub-system [104] further comprises one or more layered sub-systems having one or more initial layers and one final dense layer.

5. The method as claimed in claim 4, wherein the final dense layer of the first sub-system [104] is fine-tuned using the second sub-system [106] and the third sub-system [108].

6. A system for end-to-end automated speech recognition, the system comprising:
- a recorder [102] configured to receive a speech input in a target domain; and
- a first sub-system [104] configured to:
o process the speech input based on a data output from a second sub-system [106] and a pre-trained third sub system [108], wherein the pre-training of the third sub-system [108] is based on a historical audio data in a source domain retrieved from a memory unit [110]; and
o generate a text output for the speech input based on the processing of the first sub-system [104].

7. The system as claimed in claim 1, wherein the data output from the second sub-system [106] is a single speaker audio data based on an input text in the target domain.

8. The system as claimed in claim 1, wherein the speech input is chunked into a plurality of pieces of a predefined length.

9. The system as claimed in claim 1, wherein the first sub-system [104] further comprises one or more layered sub-systems having one or more initial layers and one final dense layer.

10. The system as claimed in claim 9, wherein the final dense layer of the first sub-system [104] is fine-tuned using the second sub-system [106] and the third sub-system [108].

11. A method for training a neural network for an end-to-end automatic speech recognition system, the method comprising:
- receiving, by a first sub-system [104] comprising a plurality of layers, a speech input data;
- obtaining an audio-text pair data in a target domain from a text data in the target domain, using a second sub-system [106], wherein the audio-text pair data in the target domain obtained from the second sub-system [106] is a single speaker audio-text pair data based on an input text in the target domain;
- pre-training a third sub-system [108] using a set of audio data in a source domain;
- fine-tuning a final layer of the first sub-system [104] using the audio-text pair data obtained using the second sub-system [106] and the pre-trained third sub-system [108].

12. The method as claimed in claim 11, wherein the speech input is chunked into a plurality of pieces of a predefined length.

13. A system for training a neural network for an end-to-end automatic speech recognition system, the system comprising:
- a first sub-system [104] comprising a plurality of layers, configured to receive a speech input data;
- a second sub-system [106], configured to obtain an audio-text pair data in a target domain from a text data in the target domain, wherein the audio-text pair data in the target domain obtained from the second sub-system [106] is a single speaker audio-text pair data based on an input text in the target domain;
- a third sub-system [108], wherein the third sub-system [108] is pre-trained using a set of audio data in a source domain;
- wherein the first sub-system [104] is configured to fine-tune a final layer of the first sub-system [104] using the audio-text pair data obtained using the second sub-system [106] and the pre-trained third sub-system [108].

14. The system as claimed in claim 13, wherein the speech input is chunked into a plurality of pieces of a predefined length.
